(19) United States
(12) Patent Application Publication
(10) Pub. No.: US 2009/0008280 A1
(43) Pub. Date: Jan. 8, 2009

(54) Tool organizer insert

(76) Inventors: Burak Nilferli, Costa Mesa, CA (US); Munir Arin, San Diego, CA (US)

Correspondence Address: PATENT LAW & VENTURE GROUP, 2424 S.E. BRISTOL, SUITE 300, NEWPORT BEACH, CA, 92660, US

(21) Appl. No.: 11/825,296

(22) Filed: Jul. 4, 2007

(51) Int. Cl. B25H 3/00

(52) U.S. Cl. 206/373

(57) ABSTRACT

A tool organizer insert apparatus for a bucket holds tools, equipment, and similar objects within a plurality of round tubes joined in side-by-side alignment. The insert has an outer circumference which frictionally engages the inner wall surface of the bucket, leaving a center area of the bucket unobstructed and available for storage of larger objects not stored within the tubes. In certain embodiments the tubes are molded using a rigid, transparent, thermoplastic material, with each one of the tubes having a selected height and diameter. In another embodiment, the tubes are made of a relatively elastic material, allowing the insert some degree of flexibility in order to conform to containers of various shapes and sizes. In yet another embodiment, the insert and bucket are molded as a single unit.

### BACKGROUND OF THE INVENTION

1. Field of the Present Disclosure

This disclosure relates generally to tool organizers, and more particularly, to a tool organizer insert adapted to be inserted into and carried by a bucket, and more particularly to such an insert for integral part of the bucket comprising side-by-side tube structures.

2. Description of Related Art including Information Disclosed Under 37 CFR 1.97 and 1.98

Dickerson, U.S. Pat. No. 2,835,406 discloses a nipple kit consisting of a metal carrying device with slots therein for carrying an assortment of various sized plumbing nipples.

Denholtz, U.S. Pat. No. 4,305,511 discloses a storage device for kitchen utensils, tools, artist supplies, etc. providing annular tiers of storage pockets surrounding a central hollow cylinder whose top contains apertures to support bladed utensils; preferably, the main body of the storage device is a unitary molded plastic structure having spaced double walls between the storage pockets so as to provide additional storage for bladed utensils between the double walls and the entire device is supported for rotation about the central axis of the cylinder.

Deyesso et al, U.S. Pat. No. 4,362,243 discloses a tool holder insert adapted to engage the inner surface of the wall of a plastic bucket between the open end and closed bottom. The insert is annular in configuration and includes apertures and notches for holding tools, sporting equipment and the like. A variation of the tool holder is a strip of metal which is bent into a sinuous, circular configuration which is fastened to the inner surface of the wall of the plastic bucket between the open end and closed bottom. The sinuous configuration of the variation provides notches and flutes which hold the tools, etc.

Franklin, U.S. Pat. No. 4,715,499 discloses an automotive roll-up tool kit. The tool kit is of flexible plastic and has a plurality of compartments or open top pockets receiving the tools and increasing in size from one end of the kit to the other. The front of the compartment is constructed of transparent plastic for further identification of the tool with the top flap closed. A top turn over flap ensures that the tools do not fall out and is marked with registering names of the tools. A trouble-shooting instruction manual is inserted in one of the pockets. A tab at one end is provided with Velcro pads adapted to stick to mating Velcro pads on the back of the tool kit when the tool kit is rolled up.

Mains, U.S. Pat. No. 4,867,332 discloses a tool holder which holds tools, implements, equipment and other such objects within a container such as a five-gallon bucket. The tool holder is characterized in having an upstanding annular wall which extends along a partial sector of a circle and which carries at its lower end a radially inwardly projecting horizontal ledge. An outwardly and downwardly extending lip is formed about the upper circumference of the annular wall for releasable engagement with the upper rim of the bucket. With the lip engaged on the bucket rim the ledge is supported within the bucket. In certain embodiments openings are formed through the ledge for receiving and supporting the tools and implements. In another embodiment radially extending side walls and an inner wall cooperate with the annular wall and ledge to form a box-shaped container for holding the tools and implements.

Fogelberg, U.S. Pat. No. 5,186,329 discloses a tool holder especially adapted to be received within a standard five-gallon dry wall pail or like container. The tool holder is characterized in having an outer side wall, preferably tapered to be compatible with the taper of the dry wall pail or like container. The outer side wall surrounds a cavity within which tools may be stored. The cavity is subdivided by generally vertical walls into a number of tool compartments of various sizes, with the highest and deepest compartments located near the periphery of the cavity and the lowest and shallowest compartments located near the center of the cavity. In a preferred embodiment the tool compartments reflect an inclined plane spiral arrangement, the spiral being lowest in the center of the cavity and moving upward as the spiral approaches the tool holder periphery.

Darrey, U.S. Pat. No. 5,350,065 discloses an apparatus for carrying hand tools which comprises an adaptation for a bucket. The adaptation further comprises a bucket insert with a planar and circular top member to be positioned at or near and across the top of the bucket and a cylindrical cavity down through the center of the bucket. The circular top member is adapted with a series of holes and slots to receive tools and the cylindrical cavity is adapted to facilitate the maneuver of a person's hand. In an alternative embodiment, the insert may be permanently fixed to the bucket.

Varnom, U.S. Pat. No. 5,836,446 discloses a tool carrying insert for a bucket, the insert having an upper plate rigidly joined by a centrally located vertical connector to a dish spaced below the plate; the plate being of a size to overhang the rim of a bucket, being pierced by a plurality of passageways to receive and hold tools positioned vertically, and having a centrally located handle projecting upwardly therefrom; the dish being a flat open shallow container with upwardly disposed outer edges and having a plurality of spaced partitions with the bottom of the dish spaced upwardly from the bottom of the bucket.

Zajonc, U.S. Pat. No. 5,924,568 discloses a tool container insert for a bucket which is removably situated within the bucket and further includes a handle for facilitating the removal thereof. The tool container insert further includes a pair of upstanding plates connecting a top plate and a bottom plate of the tool container insert. The upstanding plates have a generally V-shaped vertical cross-section and converge from top to bottom. The top plate and the bottom plate have a periphery of a similar shape and size substantially equal to a bottom of the bucket.

Rideout, U.S. Pat. No. 6,360,891 discloses an illuminated tool organizer to illuminate tools in dark or dimly lighted areas. For this purpose, the tool organizer is arranged for receiving and securing a flashlight, or other portable light source, in a position to illuminate portions of the tool organizer. The illuminated tool organizer includes an upper rack that defines a plurality of openings to receive tools for supporting the same from the upper rack. In addition, a lower base defining a base platform from which to support tools thereon is disposed below the upper rack. To fix the upper rack in spaced relation to the lower base, a support structure is provided to extend upward from the lower base to the upper rack to fix the same at a predetermined elevation above the lower base. In order to receive and secure a flash light in either a horizontal or vertical position, a cradle is disposed adjacent the upper rack. The cradle is formed to define an opening for receiving a flashlight in an upright substantially vertical position. With this arrangement, the flashlight is moveable from a first stored position where portions thereof extend downward through the opening, to a second operating position where the flashlight is supported in an upright position, above the upper rack, such that light from the illuminating end of the flashlight is directed downward to illuminate the region between the upper rack and the lower base.

Persinger, U.S. Pat. No. 6,364,150 discloses an ice fishing bucket for organizing and transporting ice fishing rods and tackle. The invention includes a plastic bucket with a removable lid, the lid having a large hole cut in it and a foam ring fitted around the inner periphery of the hole. Slits are cut radially along the inner circumference of the foam ring for securing fishing rods. A foam disk with holes for receiving the handle ends of ice fishing rods is fitted into the bottom of the bucket. The holes are spaced in vertical alignment with the slits in the foam ring above. To organize the fishing rods, the handle of a rod is placed in one of the holes in the foam disk and the rod is then pushed into the corresponding slit in the foam ring on the bucket lid. Friction between the rod and the slits in the foam ring holds the rods in place. Other items such as tackle and lures may be placed in the center of the bucket.

Kaplan et al, US 2006/0144732 discloses a tool caddy comprising a rigid bucket and a non-rigid tool organizer. The bucket comprises a bottom support portion, with vertical walls extending upwardly therefrom, forming front, back and side faces and defining a bucket interior, and an upper rim. The bucket further comprises at least two wheels and a retractable arm with a handgrip. The arm is extendable between a fully extended position and a fully retracted position and is attached to the bucket at the back face thereof. The bucket also has a sheath, integral with the back face of the bucket and giving rise to a receptacle adapted for slidingly receiving the arm. The tool organizer comprises exterior flaps adapted to cover outward faces of the bucket and interior flaps adapted to cover interior faces of the bucket. The exterior flaps are of sufficient length to substantially cover at least the entire front face of the bucket and is formed so as to not interfere with the operation of the wheels. The tool organizer also has contrivances, disposed on the flaps, for retaining various articles.

Liu, US 2007/0023307 discloses a tool box including a housing having a number of orifices formed in an upper wall, and a carrier slideably received in the housing and having a number of socket openings for receiving tool members. The carrier is slidable relative to the housing for selectively moving the tool members in and out of the housing. A spring member may be engaged between the housing and the carrier, for biasing the carrier to move the tool members out of the housing. The carrier includes a bore for slideably receiving a guide post of the housing, and for guiding the carrier to move up and down relative to the housing. An anchoring device may anchor the carrier to the housing at the inwardly storing position.

The related art, described above, discloses tool holders and tool holder inserts for containers. The types of prior art holders include securement plates having apertures for organizing tools, compartmented inserts and holders, and carriers providing compartments. However, the prior art fails to disclose an arrangement of tool receiving tubes that may be inserted into a range of container shapes and sizes in such a way as to maximize storage space efficiency. The present disclosure distinguishes over the prior art providing heretofore unknown advantages as described in the following summary.

### BRIEF SUMMARY OF THE INVENTION

This disclosure teaches certain benefits in construction and use which give rise to the objectives described below.

Using organizer inserts in combination with buckets and similar containers is common practice for a variety of purposes, including tool organization. However, the prior art fails to disclose an organizer insert that is capable of conforming to a wide range of bucket shapes and sizes. The present apparatus solves this problem by providing, in one embodiment, an insert made of a relatively elastic material, allowing some degree of flexibility. The insert comprises a plurality of round tubes joined in side-by-side alignment, and configured with selective diameters and lengths in order to accept a variety of hand tools and other workshop implements. The tubes are round as this shape has been found to have advantages with respect to weight to strength ratio and also provides an ideal shape for storing many elongated tools such as drill bits and such, where a tool held within a round tube is not easily hidden in a corner of the compartment and is easily extracted and replaced from its holder.

In addition, the prior art references which disclose organizer inserts for buckets tend to occupy most, if not all, of the bucket's interior volume. The present apparatus, on the other hand, in one embodiment, frictionally engages the wall of a bucket, leaving a central open space within the bucket for placement of other objects including tools, supplies, and so on.

A primary objective inherent in the above described apparatus and method of use is to provide advantages not taught by the prior art.

Another objective is to provide a tool organizer insert that has a plurality of round tubes of various lengths and diameters in order to hold a wide range of hand tools and other workshop implements.

A further objective is to provide a tool organizer insert that maximizes the amount of storage space within the bucket in which it is positioned.

A further objective is to provide a tool organizer insert that is made of an elastic material such that the tubes may be configured into non-circular shapes capable of conforming to a wide range of bucket interior configurations.

A further objective is to provide a tool organizer insert that is constructed in such a manner as to be easily cut to a desired length.

A still further objective is to provide a tool organizer insert that is made of a transparent material, enabling the user to view items placed within the insert.

Other features and advantages of the present invention will become apparent from the following more detailed description, taken in conjunction with the accompanying drawings, which illustrate, by way of example, the principles of the presently described apparatus and method of its use.

### BRIEF DESCRIPTION OF THE SEVERAL VIEWS OF THE DRAWING(S)

Illustrated in the accompanying drawing(s) is at least one of the best mode embodiments of the present invention In such drawing(s):

FIG. 1 is a cross-sectional perspective view of a tool organizer insert positioned within a bucket, with the tubes arranged in a circular pattern, shown with a portion of the bucket's wall removed for clarity;

FIG. 2A is a top plan view thereof;

FIG. 2B is a cross-sectional view taken along cutting plane line 2B-2B in FIG. 2A;

FIG. 3 is a top plan view thereof showing a further embodiment in spiral formation;

FIG. 4 is a perspective view of a tube of the invention, configured for simultaneously receiving a thumb and index finger of an adult person;

FIG. 5 is a perspective view of a portion of the tubes of the invention arranged with sequentially greater length; and

FIG. 6 is a perspective view of a portion of tubes of the invention showing varying tube diameters and tube lengths.

### DETAILED DESCRIPTION OF THE INVENTION

The above described drawing figures illustrate the described apparatus and its method of use in at least one of its preferred, best mode embodiment, which is further defined in detail in the following description. Those having ordinary skill in the art may be able to make alterations and modifications to what is described herein without departing from its spirit and scope. Therefore, it must be understood that what is illustrated is set forth only for the purposes of example and that it should not be taken as a limitation in the scope of the present apparatus and method of use.

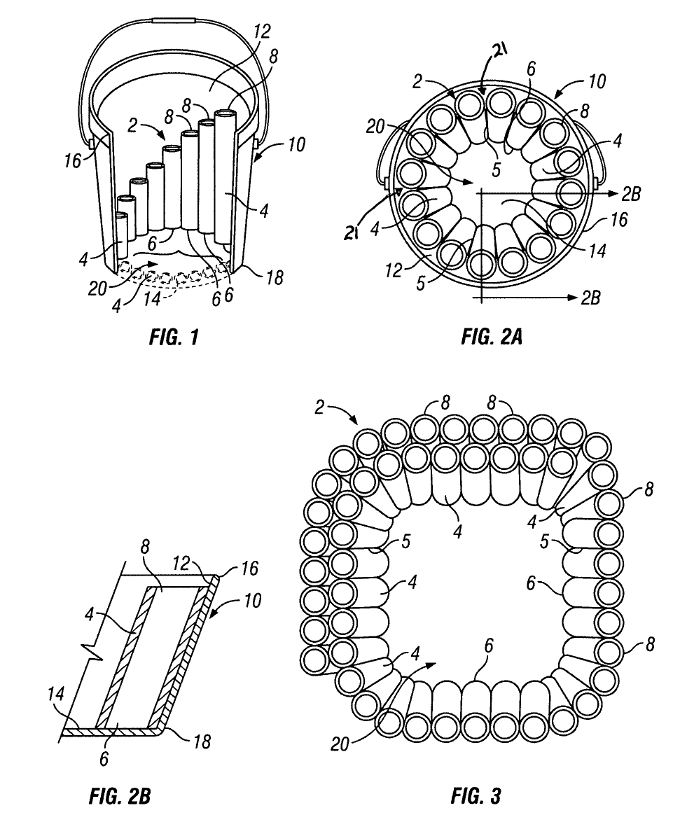

Referring now to FIG. 1, a tool organizer insert 2 is shown mounted in a bucket 10. The insert 2 comprises a plurality of round tubes 4 molded as a unitary part. The tubes 4 are aligned in a side-by-side arrangement with a tube bottom 6 of each one of the tubes 4 terminating in a common plane. In the preferred embodiment, the common plane is defined by an inner floor surface 14 of the bucket 10.

In one embodiment the insert 2 is preferably made of a rigid plastic material, which allows for a lightweight structure and enables the user to view items placed within the tubes 4. However, in another embodiment a flexible plastic material may be used for alternative advantages. Using a tubular shape improves on the prior art because it provides for a more robust structure able to secure heavy tools and objects, while occupying a minimal amount of space within the bucket 10.

Each tube 4 is connected to adjacent tubes 4 by resilient webbing 5 which acts as a hinge, allowing the insert 2 some degree of flexibility in order to be arranged in various configurations. In addition, the webbing 5 allows the user to cut away and remove a desired number of tubes 4 from the insert 2 in order to specially fit the insert 2 within a particular bucket 10 or carrier. Preferably the webbing 5 is made of plastic; however, other materials known to persons of ordinary skill in the art may be substituted.

The tubes 4 have interior space for receiving hand tools and workshop implements, herein referred to simply as items 22, as shown in FIG. 5. Additionally, each one of the tubes 4 has a length no greater than the height of the bucket 10 within which it is engaged. Thus, an upper terminating end of each tube 4, referred to as the tube top 8, is positioned somewhere at or below a lip 16 of bucket 10, as shown in FIGS. 1 and 2B.

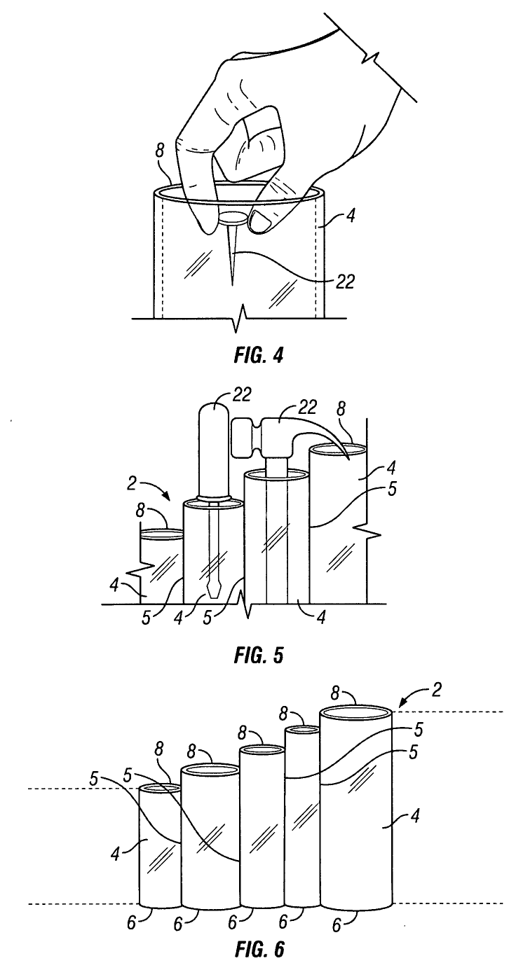

In one embodiment, each one of the tubes 4 has the same diameter and length, as shown in FIGS. 2A and 3. In another embodiment, each one of the tubes 4 is configured with selective diameters and/or lengths, as shown in FIGS. 5 and 6. Having tubes 4 of varying diameters and lengths enables a more efficient use of space within the bucket 10 as well as assists in easy retrieval of any given item 22. In another embodiment, each one of the tubes 4 is arranged in sequential order based on the length of tube 4, as shown in FIGS. 1, 5, and 6. In yet another embodiment, some of the tubes 4 may have a diameter sized for simultaneously receiving a thumb and index finger of an adult person, as shown in FIG. 4, allowing items 22, such as screws, nuts and nails, to be more easily retrieved.

Each tube bottom 6 is configured for abutting the inner floor surface 14 of bucket 10 so as to secure items 22 within tubes 4. Preferably the tubes 4 are positioned in a circular arrangement, as shown in FIGS. 1 and 2A, in such a way that the outer circumference of insert 2 is frictionally engaged with an inner wall surface 12 of the bucket 10. Because the insert 2 is engaged with the inner wall surface 12, the arrangement creates a central open space 20 within the center of the bucket 10. This central open space 20 can be used to store additional items 22 such as tools, supplies and other items that do not necessarily fit into the tubes 4. Furthermore, because the insert is made up of round tubes 4, a plurality of perimeter spaces 21 are created when the insert is engaged with the inner wall surface 12, as shown in FIG. 2A. These perimeter spaces 21 allow for storage of even more items 22.

In another embodiment, the tubes 4 are made of a relatively resilient plastic material, allowing the tubes 4 some degree of flexibility in order to be arranged in non-circular configurations, such as the spiral arrangement shown in FIG. 3, or a rectangular arrangement, depending on the size and shape of the bucket 10 within which the insert 2 is engaged. When positioned within the bucket 10, the tubes 4 are slightly compressed so as to secure the insert 2 by resilient forces.

In this embodiment, the flexible nature of the insert 2 enables it to be positioned within a wide range of sizes and shapes of buckets 10. A common type of bucket 10 is one having a cylindrical side wall with a uniform circular cross-section, as shown in FIGS. 1 and 2A. Another type of bucket 10 is one that is frusto-conical tapered with the inner wall surface 12 downwardly converging from the lip 16 to the inner floor surface 14, as shown in FIG. 2B. As already noted, other shapes and sizes, such as rectangular buckets, may also be used in combination with the insert 2. Where bucket 10 has a downwardly convergent inner wall surface 12, such as shown in FIG. 2B, the insert 2 is configured to correspond to surface 12. This has the benefit of directing the upper end of tools away from the center space 20 within the bucket 10 for improved access thereto.

In yet another embodiment, the insert 2 and bucket 10 are molded as a single unit. The tubes 4 are aligned in a side-by-side arrangement integral with the inner wall surface 12 of the bucket 10, and each tube bottom 6 is integral with the inner floor surface 14. This embodiment has the same functionality as the previously discussed embodiments. The insert 2 is not removable in this embodiment.

The enablements described in detail above are considered novel over the prior art of record and are considered critical to the operation of at least one aspect of the apparatus and its method of use and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or drawing elements described herein are meant to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

The scope of this description is to be interpreted only in conjunction with the appended claims and it is made clear, here, that each named inventor believes that the claimed subject matter is what is intended to be patented.

What is claimed is:

1. A tool organizer apparatus for use with a bucket, the apparatus comprising: an insert having a plurality of round tubes molded as a unitary part, the tubes aligned in a side-by-side circular arrangement with a tube bottom of each one of the tubes terminating in a common plane, the insert having an outer circumference frictionally engagable with an inner wall surface of the bucket.

2. The apparatus of claim 1 wherein the insert is made of a rigid transparent material.

3. The apparatus of claim 1 wherein the tubes are configured to define a central open space as well as perimeter spaces.

4. The apparatus of claim 1 wherein at least one of the tubes is sized for receiving a workshop implement.

5. The apparatus of claim 1 wherein the tubes have corresponding diameters and lengths.

6. The apparatus of claim 1 wherein the tubes are configured with selective diameter and length.

7. The apparatus of claim 1 wherein at least one of the tubes is configured for simultaneously receiving a thumb and index finger of an adult person; whereby items held within said one of the tubes are easily retrieved.

8. The apparatus of claim 1 wherein the tubes are arranged with sequentially greater length.

9. The apparatus of claim 1 wherein the insert is made of an elastic material and thereby formed into a non-circular configuration.

10. A combination portable tool organizer and carrier comprising: an insert and a bucket, the insert configured and sized for abutting engagement with an inner wall surface of the bucket; the insert made up of a plurality of round tubes molded as a unitary part, the tubes aligned in a side-by-side arrangement with a tube bottom of each one the tubes abutting an inner floor surface of the bucket.

11. The apparatus of claim 10 wherein the inner wall surface converges from a lip to the inner floor surface, the tubes corresponding thereto.

12. The apparatus of claim 10 wherein the insert is made of a compressively resilient material; the insert having an outer circumference of such magnitude as to engage the inner wall surface of the bucket compressively.

13. The apparatus of claim 10 wherein the insert is made of a rigid transparent material.

14. The apparatus of claim 10 wherein the tubes are configured to define a central open space as well as perimeter spaces.

15. The apparatus of claim 10 wherein at least one of the tubes is sized for receiving a workshop implement.

16. The apparatus of claim 10 wherein the tubes have corresponding diameters and lengths.

17. The apparatus of claim 10 wherein the tubes are configured with selective diameter and length.

18. The apparatus of claim 10 wherein at least one of the tubes is configured for simultaneously receiving a thumb and index finger of an adult person; whereby items held within said one of the tubes are easily retrieved.

19. The apparatus of claim 10 wherein the tubes are arranged with sequentially greater length.

20. A portable tool organizer comprising: a bucket having a plurality of round tubes; the bucket and tubes formed as an integral and unitary part, the tubes aligned in a side-by-side arrangement formed as part of a side wall of the bucket; the tubes terminating against and integral with a bottom of the bucket; each pair of adjacent tubes forming an essentially triangular space with the bucket side wall.
